(19) United States
(12) Patent Application Publication
(10) Pub. No.: US 2010/0001878 A1
(43) Pub. Date: Jan. 7, 2010

(54) APPARATUS FOR CONTROLLING AN OBJECT THAT IS MOVABLE WITHIN A COORDINATE SYSTEM HAVING A PLURALITY OF AXES

(75) Inventor: Robert E. DeMers, Elk River, MN (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/034,752

(22) Filed: Feb. 21, 2008

(51) Int. Cl. G08C 19/16; H01H 19/00

(52) U.S. Cl. 340/825.62; 200/5 A

(57) ABSTRACT

An apparatus is provided for controlling the movement of an object within a coordinate system having a plurality of axes. The apparatus comprises a plurality of rotatable input controls each coupled to the apparatus and rotatable about an axis that is parallel to a different one of the plurality of axes for controlling rotation of the object about the different one of the plurality of axes. In addition, the apparatus comprises a plurality of translatable input controls each coupled to the apparatus and translatable along an axis that is parallel to the different one of the plurality of axes for controlling the translation of the object along the different one of the plurality of axes.

### STATEMENT REGARDING FEDERALLY SPONSORED RESEARCH OR DEVELOPMENT

This invention was made with Government support under CEV Phase I awarded by NASA. The Government has certain rights in this invention.

### FIELD OF THE INVENTION

The present invention generally relates to control devices, and more particularly relates to a device for controlling an object that is movable within a coordinate system having a plurality of axes.

### BACKGROUND OF THE INVENTION

A variety of control devices exist for objects that are movable within a coordinate system having a plurality of axes. Such control devices provide input regarding both the rotation of the object about, and the translation of the object along, one or more predetermined axes of the coordinate system. One example of such a device utilizes two separate input controls, one to direct the rotation of the object about each of the plurality of axes and one to direct the translation of the object along each of the plurality of axes. In many instances each of these input controls is configured to move in the same manner (e.g., each input control is a joystick that pivots about a center point). When this is the case, the user can be easily confused as to which component of the object's motion (e.g., rotation or translation) is controlled by each one of the input controls. Further, the designers of these types of input controls often rely on their relative positions (e.g., left or right), or provide different shaped handles for each input control, to differentiate between them. However, this requires the user to learn which position and/or shape corresponds to which component of the object's movement and might still lead to confusion because the movement and position, or shape, of each input control does not provide any indication of how the object will move when they are actuated. Therefore, the use of two separate input controls may not be desirable for use with objects that must be moved with precision.

A second approach for providing a control device for an object that can move within a coordinate system having a plurality of axes is to use a single input control that is capable of providing input regarding both the rotation and translation of the object. For example, such an input control may itself be rotatable about, and translatable along, each of a plurality of axes to allow the user to move the control device in the same manner as the desired motion of the object. While the use of a single input control requires less space, it can make it difficult to isolate a desired component of the object's motion (e.g., rotation or translation), a problem that is known as cross-coupling. Cross-coupling may occur due to the mismatch between the mechanics of the human wrist and the mechanics of the input control. For example, if the pivot point of the control device is not positioned at the same location as the pivot point of the user's wrist, as if often the case, an attempt by the user to rotate the input control by rotating his or her wrist is likely to result in motion that has both a rotational component and a translational component. Therefore, the use of a single input control might also be undesirable for instances in which the object must be moved with precision.

Accordingly, it is desirable to provide a control device that can move an object with precision within a coordinate system having a plurality of axes. In addition, it is desirable that such a control device be compact and simple to use. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An apparatus is provided for controlling the movement of an object within a coordinate system having plurality of axes. The apparatus comprises a plurality of rotatable input controls, each coupled to the apparatus and rotatable about an axis that is parallel to a different one of the plurality of axes to control rotation of the object about the different one of the plurality of axes. In addition, the apparatus comprises a plurality of translatable input controls, each coupled to the apparatus and translatable along an axis that is parallel to a different one of the plurality of axes, to control translation of the object along the different one of the plurality of axes.

### BRIEF DESCRIPTION OF THE DRAWINGS

The present invention will hereinafter be described in conjunction with the following drawing figures, wherein like numerals denote like elements, and

FIG. 1 is an isometric view of an exemplary embodiment of the control device of the present invention;

FIG. 2 is an isometric view of a second embodiment of the present invention; and

FIG. 3 is an isometric view of a third embodiment of the present invention.

### DETAILED DESCRIPTION OF THE INVENTION

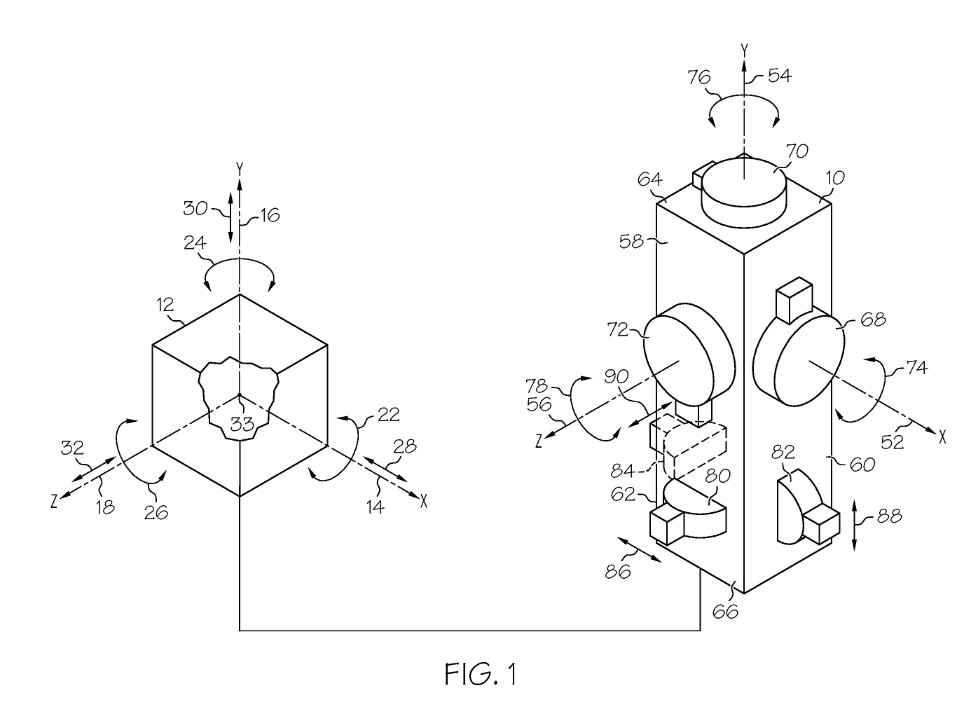

The following detailed description of the invention is merely exemplary in nature and is not intended to limit the invention or the application and uses of the invention. Furthermore, there is no intention to be bound by any theory presented in the preceding background of the invention or the following detailed description of the invention. Although the diagrams shown herein depict example arrangements of elements, additional intervening elements, devices, features, or components may be present in an actual embodiment. It should also be understood that FIGS. 1-3 are merely illustrative and may not be drawn to scale.

FIG. 1 depicts an exemplary control device 10 for controlling an object 12 that can be rotated about, and translated along, three mutually orthogonal axes: an X-axis 14, a Y-axis 16, and a Z-axis 18. It should be understood that in other embodiments, the control device 10 may be used to control objects that are movable within coordinate systems having different numbers, or configurations, of axes. For example, in one alternative embodiment, the control device 10 may be used to control an object 12 that is movable about a coordinate system comprising the X, Y, and Z-axes 14, 16, 18 and additional axes that are oriented diagonally with respect to the X, Y, and Z-axes 14, 16, 18.

The depicted object 12 is configured to rotate about each of the X, Y, and Z-axes 14, 16, 18, as indicated by arrows 22, 24, and 26, respectively, and to translate about each of the axes as indicted by arrows 28, 30, 32, respectively. From the perspective of the user, object 12 is at all times centered at the origin 33 of the coordinate system. Object 12 may comprise any object or device, real or computer generated, that can rotate about, and translate along, each of the axes in a coordinate system, including a space module, a submersible vessel, or a robotic machine.

Control device 10 is configured to provide control signals in response to user input that result in the movement of the object 12 within its coordinate system. As further described below, control device 10 provides an intuitive means for controlling the movement of the object 12 by providing a plurality of controls that rotate and translate in the same manner as the resulting rotation and translation, respectively, of the object 12. To provide this intuitive control scheme, control device 10 is positioned such that, from the perspective of the user, its coordinate system has axes that correspond to and have the same orientation as the axes of the coordinate system of the object 12. For example, in the embodiment of FIG. 1 the control device 10 is positioned at the origin of a coordinate system having three mutually orthogonal axes, an X-axis 52, a Y-axis 54, and a Z-axis 56, that are parallel to the X, Y, and Z-axes 14, 16, 18 of the coordinate system of the object 12. In other embodiments, control device 10 and the object 12 may both be positioned at the origin 33 of a shared coordinate system.

It should be understood by one who is skilled in the art that there are a number of possible respective orientations between the user, the control device 10, and the object 12. Control device 10 and object 12 may be arranged so that the X, Y, and Z-axes 52, 54, 56 of control device 10 are parallel to the X, Y, and Z-axes 14, 16, 18 of object 12. For example, the user and control device 10 may be positioned inside object 12 such that the axes of control device 10 and the axes of object 12 are aligned. Alternatively, the user and control device 10 may be positioned outside of object 12 such that the coordinate systems of both control device 10 and the object 12 are aligned.

The control device 10 and the object 12 may also be arranged such that their coordinate systems are not physically aligned, either because object 12 has a different orientation than control device 10 or because the object 12 is computer generated and does not physically exist. In this case, the user is provided with a visual representation of object 12 that is positioned within a virtual coordinate system with axes that are parallel to the axes of control device 10. For example, the user may be provided with a visual representation on a display device that depicts the view from inside of the object 12 such that the coordinate system of the control device 10 and the coordinate system of the depicted object 12 are aligned from the user's view. Further, the user may be provided with a visual representation of the entire object 12 that is oriented to align with the coordinate system of the control device 10 from the perspective of the user.

In some embodiments, the control device 10 includes a control member 58 having a plurality of surfaces. In the depicted embodiment, the control device 10 includes a control member 58 that is shaped in the form of a rectangular cube and includes two side surfaces 60, 62 that are substantially perpendicular to the X-axis 52, a top surface 64 that is substantially perpendicular to the Y-axis 54, and a front surface 66 that is substantially perpendicular to the Z-axis 56.

Control device 10 also includes a plurality of rotatable controls that provide input to the control device 10 regarding the rotation of the object 12 about each of the axes of the coordinate system. Each of these rotatable controls is coupled to control device 10 to rotate in the same manner as the intended rotation of the object 12. For example, in the depicted embodiment, control device 10 includes a first rotatable input control 68, a second rotatable input control 70, and a third rotatable input control 72 (e.g., rotatable knobs as shown), each coupled to the control member 58. The first rotatable input control 68 is disposed on side surface 60 and is configured to rotate as indicated by arrow 74 about the X-axis 52, resulting in rotation of the object 12 about its X-axis 14. The second rotatable input control 70 is disposed on the top surface 64 and is configured to rotate as indicated by arrow 76 about the Y-axis 54, resulting in rotation of the object 12 about its Y-axis 16. Finally, the third rotatable input control 72 is disposed on the front surface 66 and is configured to rotate as indicated by arrow 78 about the Z-axis 56, resulting in rotation of the object 12 about its Z-axis 18.

Each of the first, second, and third rotatable input controls 68, 70. 72 may be positioned on other surfaces of the control member 58, so long as they are rotatable about the appropriate axis. For example, in another embodiment, the first rotatable input control 68 may be positioned on side surface 62 so that it rotates about the X-axis 52. Further, the rotatable input controls 68, 70, 72 may also rotate about axes that are parallel to the X, Y, and Z-axes 52, 54, 56, respectively, resulting in similar rotation of the object 12. For example, the first rotatable input control 68 may be positioned at a different location on either of the side surfaces 60, 62 so that it rotates about an axis that is parallel to the X-axis 52 resulting in the rotation of the object 12 about its X-axis 14. Finally, although in the illustrated embodiment the first, second, and third rotatable input controls 68, 70, 72 are depicted as rotatable knobs, it will be understood by one who is skilled in the art that other types of rotatable controls may be used.

In some embodiments, rotatable input controls 68, 70, 72 may be positioned in, and, in some cases, are biased toward, a null position. In these embodiments, movement of rotatable input controls 68, 70, 72 away from the null position controls the magnitude, the rate, or the rate of acceleration of the resulting rotation of the object 12. Further, when rotatable input controls 68, 70, 72 are returned to the null position, the rotation of the object 12 may cease or the object 12 may continue to rotate at a desired rate or rate of acceleration. In still other embodiments, the object 12 rotates in concert with rotatable input controls 68, 70, 72, so that a rotation of one of the controls 68, 70, 72 by a certain number of degrees results in a corresponding rotation of the object 12 by the same amount.

Control device 10 also includes a plurality of translatable input controls that provide input to the control device 10 regarding the desired translational movement of the object 12 about each of the axes of the coordinate system. These translatable input controls are coupled to control device 10 to translate in the same manner as the resulting translation of the object 12. As depicted, the control device includes a first translatable input control 80, a second translatable input control 82, and a third translatable input control 84 each coupled to the control member 58. In the depicted embodiment, the first, second, and third translatable input controls 80, 82, 84 comprise bi-directional switches that can translate in two directions. Each translatable input control 80, 82, 84 provides input to control device 10 regarding the desired translational movement of object 12 and is coupled to the control member 58 to translate along one of the X, Y, and Z-axes 52, 54, 56 in the same manner as the intended translation of object 12. As depicted, the first translatable input control 80 is disposed on the front surface 66 and is configured to translate as indicated by arrow 86 along the X-axis 52, resulting in translation of object 12 along its X-axis 14. The second translatable input control 82 is disposed on side surface 60 and is configured to translate as indicated by arrow 88 along the Y-axis 54, resulting in translation of object 12 along its Y-axis 16. Finally, the third translatable input control 84 is disposed on side surface 62 and is configured to translate as indicated by arrow 90 along the Z-axis 56, resulting in translation of object 12 along its Z-axis 18.

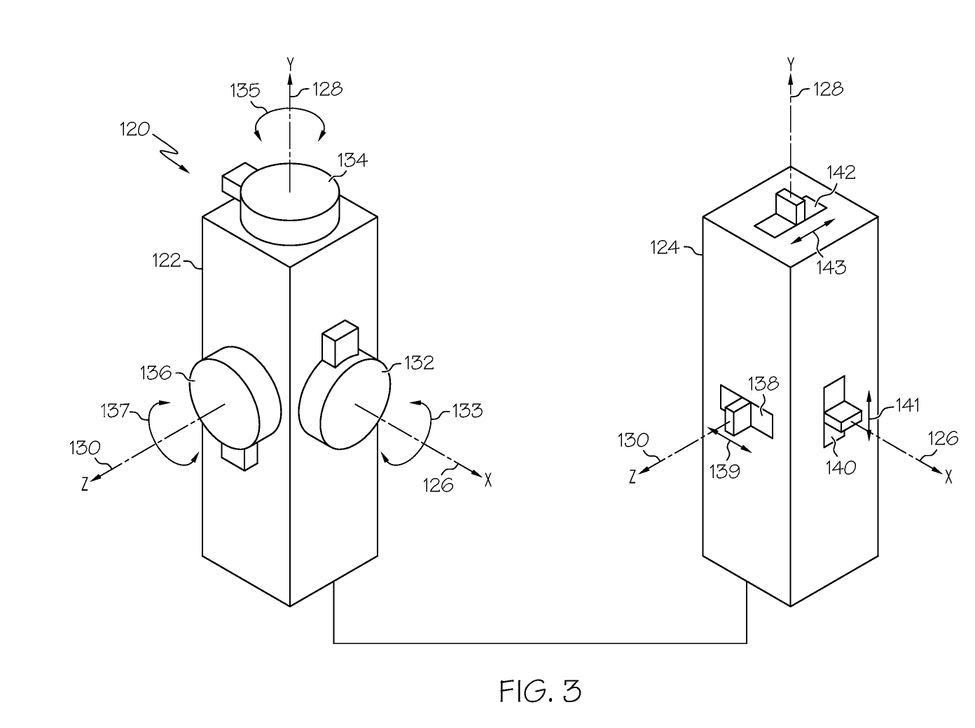

Each of the first, second, and third translatable input controls 80, 82, 84 may be positioned on other surfaces of the control member 58, so long as they are able to translate along the appropriate axis. For example, in other embodiments, the first translatable input control 80 may also be positioned on the top surface 64 and configured to translate with respect to the X-axis 52 resulting in the translation of the object 12 along its X-axis 14. Further, although in the illustrated embodiment the first, second, and third translatable input controls 80, 82, 84 are depicted as bi-directional switches that can translate in at least two directions, it will be understood by one who is skilled in the art that other controls that can translate in two directions, such as bi-directional sliding controls (as depicted in FIG. 3), may also be used.

Translatable input controls 80, 82, 84 have a null position and, in some cases, are biased toward that null position. Movement of the translatable input controls 80, 82, 84 away from the null position may control the magnitude, the rate, or the rate of acceleration of the resulting translation of the object 12. Further, when the translatable input controls 80, 82, 84 are returned to the null position the object 12 may cease translating or may continue to translate at a desired rate or a desired rate of acceleration.

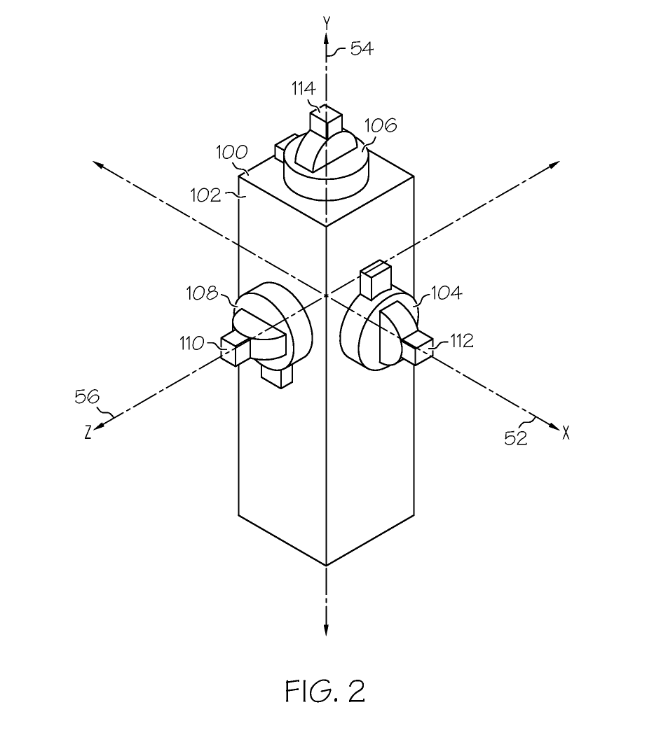

FIG. 2 is a depiction of a second embodiment of the control device 100 of the present invention. The control device 100 includes a control member 102, first, second, and third rotatable input controls 104, 106, 108, and first, second, and third translatable input controls 110, 112, 114. Each of the rotatable input controls 104, 106, 108 and translatable input controls 110, 112, 114 is coupled to the control member 102 and configured to function in the same manner, and provide the same inputs, as described above with reference to FIG. 1. However, in this embodiment each of the first, second, and third translatable input controls 110, 112, 114 is concentrically positioned within a different one of the first, second, and third rotatable input controls 104, 106, 108. Combining the rotatable input controls 104, 106, 108 and the translatable input controls 110, 112, 114 in this manner decreases the space required for the control device 100 and may be suited for use in locations where space is restricted.

FIG. 3 is a depiction of a third embodiment of the control device 120 of the present invention. This embodiment provides a first control member 122 and a second control member 124 that separately control the rotation and translation of object 12 of FIG. 1. Each of the first and second control members 122, 124 is oriented in a coordinate system having three mutually orthogonal axes: an X-axis 126, a Y-axis 128, and a Z-axis 130 that are parallel to the X, Y, and Z-axes 14, 16, 18 of FIG. 1. The first control member 122 includes a first rotatable input control 132 that is rotatable as indicated by arrow 133 about the X-axis 126 to control rotation of the object 12 of FIG. 1 about its X-axis 14, a second rotatable input control 134 that is rotatable as indicated by arrow 135 about the Y-axis 128 to control rotation of the object 12 about its Y-axis 16, and a third rotatable input control 136 that is rotatable as indicated by arrow 137 about the Z-axis 130 to control rotation of the object 12 about its Z-axis 18. The second control member 124 includes a first translatable input control 138 that is translatable as indicated by arrow 139 along the X-axis 126 to control translation of the object 12 of FIG. 1 along its X-axis 14, a second translatable input control 140 that is translatable as indicated by arrow 141 along the Y-axis 128 to control translation of the object 12 along its Y-axis 16, and a third translatable input control 142 that is translatatable as indicated by arrow 143 along the Z-axis 130 to control translation of the object 12 along its Z-axis 18. It should be noted that in the illustrated embodiment, the translatable input controls 138, 140, 142 comprise bi-directional sliding controls that can translate in two directions and are biased toward a null position (as shown).

While a number of exemplary embodiments have been presented in the foregoing detailed description of the invention, it should be appreciated that a vast number of variations exist. It should also be appreciated that these exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An apparatus for controlling movement of an object within a coordinate system having a plurality of axes, comprising:
a plurality of rotatable input controls each coupled to the apparatus and rotatable about an axis that is parallel to a different one of the plurality of axes for controlling rotation of the object about the different one of the plurality of axes; and
a plurality of translatable input controls each coupled to the apparatus and translatable along an axis that is parallel to a different one of the plurality of axes for controlling translation of the object along the different one of the plurality of axes.

2. The apparatus of claim 1, wherein the plurality of rotatable input controls comprise a plurality of rotatable knobs.

3. The apparatus of claim 1, wherein the plurality of translatable input controls comprise a plurality of bi-directional switches.

4. The apparatus of claim 1, wherein the plurality of translatable input controls comprise a plurality of bi-directional sliding controls.

5. The apparatus of claim 1, wherein each of the plurality of translatable input controls is positioned concentrically with a different one of the plurality of rotatable input controls.

6. The apparatus of claim 1, wherein the coordinate system comprises three independent X, Y, and Z-axes.

7. The apparatus of claim 6, wherein the plurality of rotatable input controls comprise:
a first rotatable input control coupled to the apparatus and rotatable about an axis that is parallel to the X-axis for controlling rotation of the object about the X-axis;
a second rotatable input control coupled to the apparatus and rotatable about an axis that is parallel to the Y-axis for controlling rotation of the object about the Y-axis; and
a third rotatable input control coupled to the apparatus and rotatable about an axis that is parallel to the Z-axis for controlling rotation of the object about the Z-axis.

8. The apparatus of claim 6, wherein the plurality of translatable input controls comprise:
a first translatable input control coupled to the apparatus and translatable along an axis that is parallel to the X-axis for controlling translation of the object along the X-axis;
a second translatable input control coupled to the apparatus and translatable along an axis that is parallel to the Y-axis for controlling translation of the object along the Y-axis; and
a third translatable input control coupled to the apparatus and translatable along an axis that is parallel to the Z-axis for controlling translation of the object along the Z-axis.

9. The apparatus of claim 6, further comprising a first control member and wherein the plurality of rotatable input controls further comprise:
a first rotatable input control coupled to the first control member and rotatable about an axis that is parallel to the X-axis for controlling rotation of the object about the X-axis;
a second rotatable input control coupled to the first control member and rotatable about an axis that is parallel to the Y-axis for controlling rotation of the object about the Y-axis; and
a third rotatable input control coupled to the first control member and rotatable about an axis that is parallel to the Z-axis for controlling rotation of the object about the Z-axis.

10. The apparatus of claim 9, wherein the plurality of translatable input controls further comprise:
a first translatable input control coupled to the first control member and translatable along an axis that is parallel to the X-axis for controlling translation of the object along the X-axis;
a second translatable input control coupled to the first control member and translatable along an axis that is parallel to the Y-axis for controlling translation of the object along the Y-axis; and
a third translatable input control coupled to the first control member and translatable along an axis that is parallel to the Z-axis for controlling translation of the object along the Z-axis.

11. The apparatus of claim 9, further comprising a second control member and wherein the plurality of translatable input controls further comprise:
a first translatable input control coupled to the second control member and translatable along an axis that is parallel to the X-axis for controlling translation of the object along the X-axis;
a second translatable input control coupled to the second control member and translatable along an axis that is parallel to the Y-axis for controlling translation of the object along the Y-axis; and
a third translatable input control coupled to the second control member and translatable along an axis that is parallel to the Z-axis for controlling translation of the object along the Z-axis.

12. A control device for controlling movement of a visual representation of an object within a coordinate system having three independent X, Y, and Z-axes, the control device comprising:
three rotatable input controls each coupled to the control device and rotatable about an axis that is parallel to a different one of the three independent X, Y, and Z-axes for rotating the visual representation of the object about the different one of the three independent X, Y, and Z-axes; and
three translatable input controls each coupled to the control device and translatable along an axis that is parallel to a different one of the three independent X, Y, and Z-axes for translating the visual representation of the object along a different one of the three independent X, Y, and Z-axes.

13. The control device of claim 12, wherein each of the three translatable input controls is positioned concentrically with a different one of the three rotatable input controls.

14. The control device of claim 12, further comprising a first control member and wherein the three rotatable input controls comprise:
a first rotatable input control coupled to the first control member and rotatable about an axis that is parallel to the X-axis for controlling rotation of the visual representation of the object about the X-axis;
a second rotatable input control coupled to the first control member and rotatable about an axis that is parallel to the Y-axis for controlling rotation of the visual representation of the object about the Y-axis; and
a third rotatable input control coupled to the first control member and rotatable about an axis that is parallel to the Z-axis for controlling rotation of the visual representation of the object about the Z-axis.

15. The control device of claim 14, wherein the three translatable input controls comprise:
a first translatable input control coupled to the first control member and translatable along an axis that is parallel to the X-axis for controlling translation of the visual representation along the X-axis;
a second translatable input control coupled to the first control member and translatable along an axis that is parallel to the Y-axis for controlling translation of the visual representation of the object along the Y-axis; and
a third translatable input control coupled to the first control member and translatable along an axis that is parallel to the Z-axis for controlling translation of the visual representation along the Z-axis.

16. The control device of claim 14, further comprising a second control member and wherein the three translatable input controls comprise:
a first translatable input control coupled to the second control member and translatable along an axis that is parallel to the X-axis for controlling translation of the visual representation along the X-axis;
a second translatable input control coupled to the second control member and translatable along an axis that is parallel to the Y-axis for controlling translation of the visual representation of the object along the Y-axis; and
a third translatable input control coupled to the second control member and translatable along an axis that is parallel to the Z-axis for controlling translation of the visual representation along the Z-axis.

17. An apparatus for controlling movement of an object within a coordinate system having a plurality of axes, comprising:
a plurality of rotatable input controls each coupled to the apparatus and rotatable about a different one of the plurality of axes for controlling rotation of the object about the different one of the plurality of axes; and
a plurality of translatable input controls each coupled to the apparatus and translatable along a different one of the plurality of axes for controlling translation of the object along the different one of the plurality of axes.

18. The apparatus of claim 17, wherein the coordinate system comprises three independent X, Y, and Z-axes.

19. The apparatus of claim 18, wherein the plurality of rotatable input controls comprise:
a first rotatable input control coupled to the apparatus and rotatable about the X-axis for controlling rotation of the object about the X-axis;
a second rotatable input control coupled to the apparatus and rotatable about the Y-axis for controlling rotation of the object about the Y-axis; and
a third rotatable input control coupled to the apparatus and rotatable about the Z-axis for controlling rotation of the object about the Z-axis.

20. The apparatus of claim 18, wherein the plurality of translatable input controls comprise:
a first translatable input control coupled to the apparatus and translatable along the X-axis for controlling translation of the object along the X-axis;
a second translatable input control coupled to the apparatus and translatable along the Y-axis for controlling translation of the object along the Y-axis; and
a third translatable input control coupled to the apparatus and translatable along the Z-axis for controlling translation of the object along the Z-axis.
